(19) United States
(12) Patent Application Publication
(10) Pub. No.: US 2025/0050215 A1
(43) Pub. Date: Feb. 13, 2025

(54) INTERACTIVE MAP USER INTERFACE SYSTEM

(71) Applicant: Homiee Pty Ltd, Melbourne (AU)

(72) Inventors: Steven Tzatzimakis, Melbourne (AU); James Li, Melbourne (AU)

(21) Appl. No.: 18/608,744

(22) Filed: Mar. 18, 2024

(30) Foreign Application Priority Data
Aug. 8, 2023 (AU) 2023902498

(51) Int. Cl. A63F 13/5378; G06F 3/04817; G06F 3/0486; G06T 7/13; G06V 10/764

(52) U.S. Cl. CPC A63F 13/5378; G06F 3/04817; G06F 3/0486; G06T 7/13; G06V 10/764; G06T 2207/30184

(57) ABSTRACT

The provided interactive map user interface is through a server connected to multiple computer devices via the internet, equipped with a processor and memory to store and execute program code for various controllers. These controllers manage polygonal data for creating polygonal icons on the map, alongside user profile and classification data. The interface allows for dynamic navigation and displays maps enriched with geographic data, where polygonal icons—generated through polygon recognition techniques like edge detection—are overlaid. These icons can be color-coded based on classifications, such as sale history, to visually represent properties. Additionally, the system may include geocoding capabilities to convert street addresses into precise geographic locations, facilitating spatial analysis and enhancing user interaction with property data. Users can also interact by placing and shaping new icons, associating their profiles with these icons, and participating in mapping property shapes, thereby enriching the map interface with user-generated content and classifications.

### FIELD OF THE INVENTION

This invention relates generally to an interactive map user interface system.

### BACKGROUND OF THE INVENTION

An interactive map is a digital map that allows users to engage with and manipulate the displayed information. Unlike traditional static maps, interactive maps enable users to interactively explore and customise the data presented on the map based on their preferences and needs.

Interactive maps typically offer various features and functionalities, wherein users can zoom in and out of the map to view different levels of detail, from a global view down to a street-level perspective or can move the map in different directions to navigate to different areas.

Interactive maps are commonly used on websites, mobile apps, and other digital platforms to provide users with dynamic and engaging ways to explore geographic information. They find applications in various fields, including travel and tourism, real estate, urban planning, navigation, education, and more.

Interacting with icons on an interactive map can be a convenient and informative way to access location-based information, but it can also come with some challenges and problems.

For example, icons that vary in size, style, or colour can lead to confusion about their meaning. A lack of consistency in icon design can make it challenging for users to quickly understand what each icon represents.

Furthermore, loading a large number of icons on an interactive map can lead to performance issues, especially on devices with limited processing power or slower internet connections. Slow load times or laggy interactions can negatively impact the user experience.

Allowing users to interact with interactive icons on a map can enhance engagement and provide more accurate and up-to-date information. However, it also introduces several challenges and potential problems including that enabling user editing introduces complexity to the map interface. Users might find it challenging to understand how to edit icons, leading to frustration and reduced usability.

Furthermore, user-contributed icons might not adhere to a consistent design or style, leading to visual inconsistencies across the map.

Also, implementing a user-editing system requires technical infrastructure for storing, managing, and displaying edited data. Ensuring this system is robust, secure, and scalable is essential.

Furthermore, users might have different levels of expertise when it comes to editing icons. Some might contribute high-quality updates, while others might unintentionally introduce errors or confusion.

The present invention seeks to provide a system for controlling an interactive map user interface, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a system designed to control an interactive map user interface. The system consists of a server connected to multiple computer devices through the internet. The server has a processor and memory for storing program code instructions. These instructions are divided into controllers, including one for managing polygonal data used for generating polygonal icons on the map. The system also deals with user profile data, classification data, and uploaded information related to user profiles and icons.

The interactive map interface includes navigation controls and displays a map generated from geographic data. Polygonal icons are overlaid on the map, and their shapes are defined by polygonal data. These icons may be automatically generated using techniques like polygon recognition, employing algorithms such as edge detection and shape matching. The icons' shapes may also be filled with colour based on classification data.

The polygon recognition controller may be configured to identify polygons based on provided geographic coordinates, utilising GIS data to generate maps that include satellite imagery of building outlines wherein geographic locations, specified in latitude and longitude, are matched to these building outlines, allowing for the precise identification of locations on the map. The polygonal icon controller may generate polygon icons by recognising the shapes of building outlines, using the geographic locations as reference points for detecting edges and vertices. Additionally, each geographic location may be assigned a classification, with the polygonal icon controller colouring the polygons according to this classification. For instance, properties can be classified based on their sale history, with different colours representing whether a property is for sale or was sold within specific time frames. The system may include functionality for converting street addresses into the GIS geographic location data through geocoding. If an exact address match is not found, the system can estimate the location based on nearby addresses. This setup enables spatial analysis and the visual representation of properties based on their classification, improving the user's ability to interact with and understand property data on the map.

The system may also allow users to interact with the map by placing new icons, and control their shapes using interactive controls. The icons can be colour-coded based on their classifications, and a legend explains the colours. Users can associate their profiles with icons, allowing them to upload additional information displayed to others. The system also supports interactive games involving placing property shapes on a map grid.

In summary, the system allows for managing an interactive map interface with polygonal icons, user profiles, and classification features, as well as interactive gaming capabilities.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 illustrates a system for controlling an interactive map user interface. The system consists of a server connected to various computer devices via the internet. The server includes a processor and memory for storing program instructions. The memory holds polygonal data used to generate polygonal icons on the interface. These icons are based on geographical features and their attributes, stored in a standard format like GeoJSON. The computer program instructions are divided into controllers, including a polygonal icon controller and a user profile controller. The interface can display user-provided information related to polygonal icons, which can be classified using a data classifier. The server communicates through a data interface, and each computer device executes a web browser application to render the HTML responses from the server.

FIG. 2 showcases the interactive map interface, generated by the user interface controller, with navigational controls and a map composed of GIS data. The polygonal icon controller generates polygonal icons overlaid on the map, with shapes based on polygonal data. Automatic generation of icons involves interaction with a polygon recognition controller. This controller recognises polygons using image data, such as satellite image data, obtained from a data server, utilising edge detection and the Hough Transform to identify polygon edges and vertices.

FIGS. 3 and 4 depict techniques for rendering polygonal icons. FIG. 3's technique involves drawing lines between vertices, determining the centre of the polygon, and connecting vertices sequentially to enclose the polygon's boundaries. FIG. 4's method generates parallelogram shapes using parallel lines between vertices. Complex polygonal icons can be constructed from adjoining quadrilateral shapes.

FIGS. 5-8 show an embodiment wherein the polygon recognition controller is configured to recognise polygons with reference to provided geographic coordinates.

### DESCRIPTION OF EMBODIMENTS

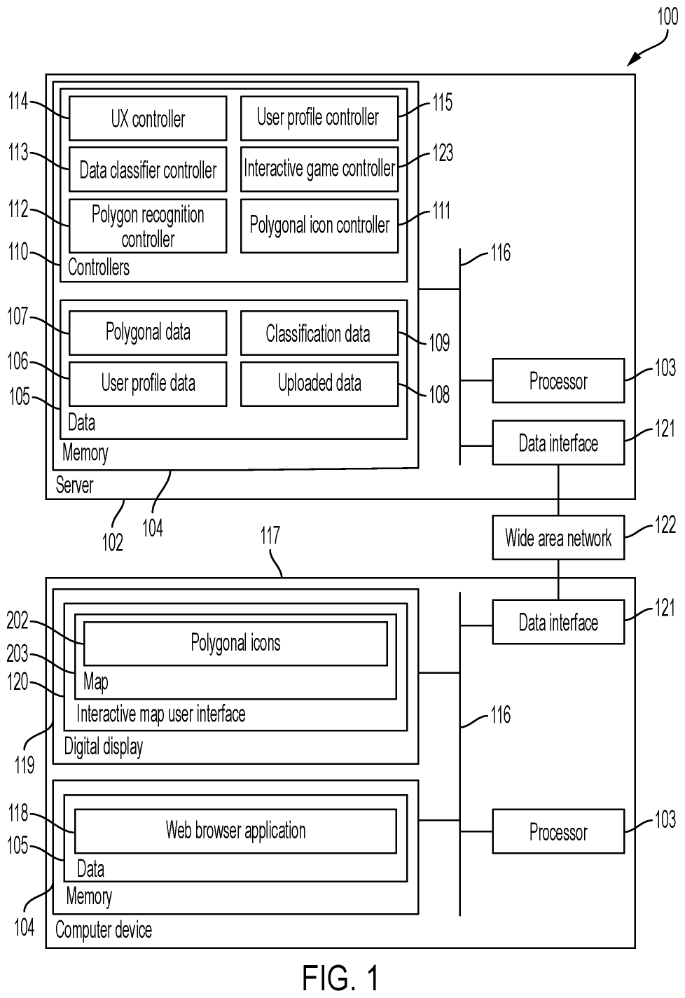

FIG. 1 shows a system 100 for controlling an interactive map user interface 120.

The system 100 comprises a server 102 in operable communication with a plurality of computer devices 117 across a wide area network 122, such as the Internet.

The server 102 comprises a processor 103 for processing digital data. In operable communication with the processor 103 via a system bus 116 is a memory device 104. The memory device 104 is configured for storing digital data including computer program code instructions. In use, the processor 103 is configured for fetching, decoding and executing these computer program code instructions and associated data for implementing the computational functionality described herein.

Data 105 stored by the memory 104 may comprise polygonal data 107 used by the system 100 for generating polygonal icons 202. The polygonal data 107 may include shape data encoded in a standard format, such as GeoJSON which encodes geographic data structures using JavaScript Object Notation (JSON) and which can be used by the system for representing geographical features of the polygonal icons and their associated attributes.

The computer program code instructions may be logically divided into a plurality of computer program code instruction controllers 110.

The controllers 110 may comprise a polygonal icon controller 111 which is configured for controlling the polygonal data 107.

The data 105 may further include user profile data 106. Similarly, the user profile data 106 may be controlled by a corresponding user profile controller 115. As will be described in further detail below, user profiles 106 may be associated with respective polygonal icons 202 within the interface 120.

The data 105 may further comprise uploaded data 108 which is uploaded in relation to user profiles 106 and associated polygonal icons 202 for the display of user provided information within the interface 120.

The data 105 may further comprise classification data 109 stored in relation to the polygonal data 107. The controllers 110 may comprise a data classifier 113 configured to generate the classification data 109. As will be described in further detail below, the data classifier 113 may be configured for classifying polygonal icons according to GIS data or other data. In this regard, the server 102 may be in operable communication with a data server 101 for obtaining the GIS data or other data for classification by the data classifier 113.

The controllers 110 may further comprise an interactive game controller 123 configured for allowing users to participate in interactive games involving the polygonal icons 202.

The server 102 may comprise a data interface 121 for sending and receiving data across the wide area network 122.

Similarly, each computing device 117 may comprise the aforedescribed computer componentry including processor 103, memory device 104 et cetera.

The computer device 117 may execute a web browser application 118 configured to send HTTP requests responses to the server 102 for the purposes of rendering HTML responses served in response thereto by a web server application of the server 102.

The computer device 117 may comprise a digital display 119 for the display of digital data thereon. The web browser application 118 may control the digital display 119 to display the interactive map interface 120 thereon.

The computer device 117 may similarly comprise a data interface 121 for sending and receiving data across the wide area network 122.

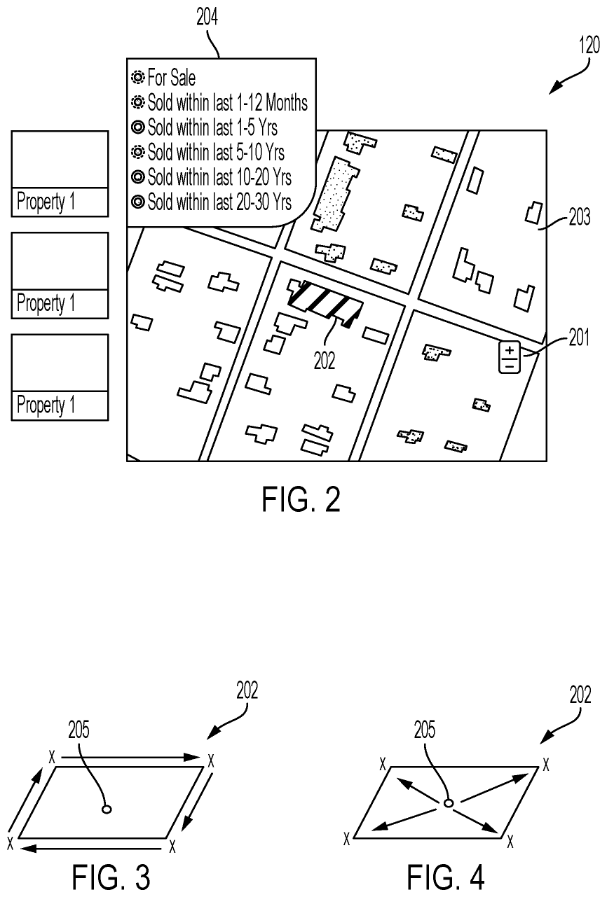

FIG. 2 shows the interactive map interface 120 in accordance with an embodiment.

The user interface controller 114 is configured to generate the interactive map user interface 120 for display by the digital displays 119 of the computer devices 117.

The user interface 120 may comprise navigational controls 201 for navigating the map.

As can be seen from FIG. 2, the interactive map interface 120 may comprise a map generated using GIS data. Such GIS data may comprise survey data relating to boundaries, streets, and the like and/or satellite data imagery.

The polygonal icon controller 111 is configured to generate a plurality of polygonal icons 202 in relation to the map 203 wherein the user interface controller 114 is configured to overlay the map 203 with the polygonal icons 202.

As alluded to above, the geometry of the polygonal icons 202 may be represented by the polygonal data 107.

In embodiments, the polygonal icon controller 111 is configured to automatically generate the polygonal icons 202. In this regard, the polygonal icon controller 111 interact with the polygon recognition controller 112.

The polygon recognition controller 112 is configured to recognise polygons using satellite image data associated with the map 202. As alluded to above, the server 102 may obtain the satellite image data from the data server 101.

The polygon recognition controller 112 may employ edge detection algorithms (such as the Canny edge detection algorithm) to identify polygon edges in the satellite data. Then, the polygon recognition controller 112 may apply the Hough Transform to detect lines in the edge-detected image. In a polygon, the intersections of these lines could correspond to the vertices of the polygon.

FIG. 3 shows a technique used by the polygonal icon controller 111 for fast rendering of a polygonal icon 202 wherein the polygonal icon controller 111 draws lines in series between vertices.

In accordance with this technique, the polygonal icon controller 111 is configured to determine the centre point 205 of the polygon 202 with reference to the vertices calculated above. In alternative embodiments as will be described in further detail below, the point 205 may be provided geographic coordinates (such as a latitude and longitude) which is referenced by the polygon icon controller 114 as a starting point for generating the boundaries of the associated proximate imagery.

Then, the polygonal icon controller 112 is configured to select one of the vertices as a start vertex and a next vertex and generate a line between these two vertices, whereafter the next vertex is identified for the generation of an associated line and so on until the boundaries of the polygonal icon 202 are enclosed. Thereafter, the polygonal icon controller 112 may fill the outline with colour. As will be described in further detail below, the colour may correspond with the classification determined by the data classifier controller 113.

FIG. 4 shows an alternative technique used by the polygonal icon controller 112 for fast rendering a polygonal icon 202 wherein the polygonal icon controller 112 is configured to generate a parallelogram shape by generating parallel lines between respective vertices.

According to this technique, the polygonal icon controller 112 determines the centre point 205 of the polygon (or wherein the centre point 205 is provided as latitude and longitude coordinates as mentioned above) whereafter parallel lines are run from respective surrounding vertices, thereby defining a parallelogram which can then be filled in the aforedescribed manner.

Whereas the techniques of FIGS. 3 and 4 generate quadrilateral shapes, the more complex shapes of the polygonal icons 202 shown in FIG. 2 may be generated by a plurality of adjoining quadrilateral shapes.

In embodiments, the polygon recognition controller 112 may employ contour detection to detect the contours of objects in the satellite image data, such as by using techniques like the OpenCV findContours function, to analyse the detected contours to identify shapes with a specific number of sides, which would correspond to the polygons.

In further embodiments, the polygon recognition controller 112 may employ contour detection algorithms like Harris or Shi-Tomasi to identify the corners of objects in the satellite image data. The corners of a polygon would be the vertices of the shape.

In yet further embodiments, the polygon recognition controller 112 would employ shape matching which uses a predefined set of polygon templates (triangles, squares, pentagons, etc.) and wherein contours or edge representations of objects in the satellite image data are compared to these templates using techniques like shape context or Hu moments. The template with the closest match could indicate the detected polygon.

Yet further, the polygon recognition controller 112 may employ deep learning by training a convolutional neural network (CNN) on a dataset of labelled images containing polygons. The CNN can learn to detect and classify polygons based on their visual features.

In some cases, the polygon recognition controller may further employ image processing and geometric analysis which analyses the pixel values in the satellite image data and use geometric techniques to identify regular patterns or symmetries that indicate the presence of polygons.

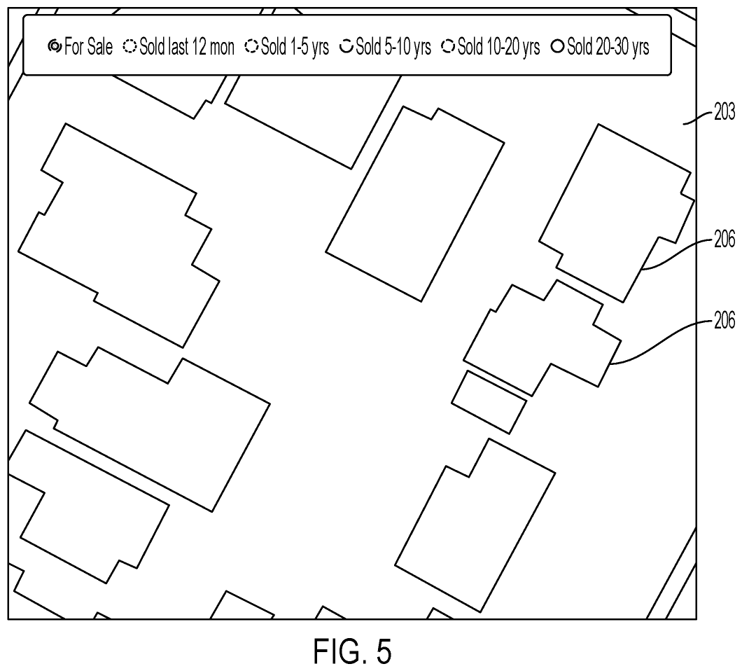

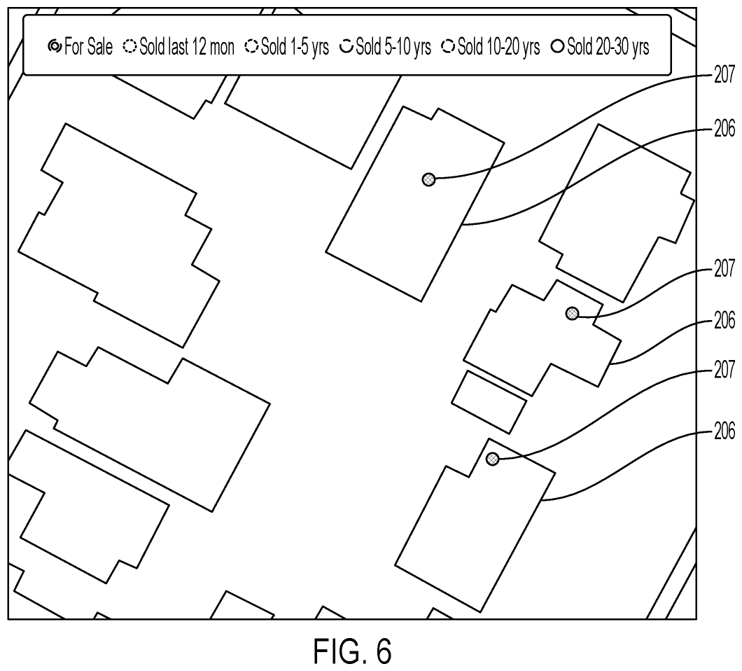

FIGS. 5-8 show an embodiment wherein the polygon recognition controller 112 is configured to recognise polygons 202 with reference to provided geographic coordinates. Specifically, FIG. 5 shows a map 203 generated using GIS data. In this example, the map 203 comprises satellite imagery data showing various building outlines 206.

FIG. 5 shows wherein geographic locations 207 are provided in latitude and longitude format which have respective locations on the map 203.

In the embodiment shown, these geographic locations 207 correspond with associated building outlines 206.

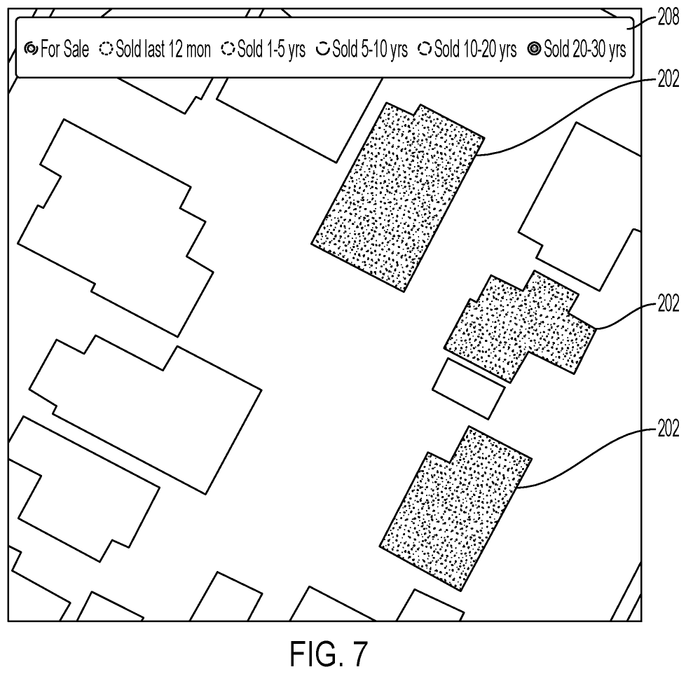

FIG. 7 shows wherein the polygonal icon controller 111 is configured to generate a plurality of polygon icons 202 by recognising the shapes of the surrounding building outlines 206 as mentioned above wherein the polygonal icon controller 115 uses the provided geographic locations 207 as the starting point of centre point 205 of the edge and/or vertices detection as described above.

Each geographical location 207 may be provided with an associated classification and wherein the polygonal icon controller 115 colours the recognised polygon 202 according to the classification. In the example shown in FIG. 7, the map 203 comprises a legend 208 comprising sale history bands indicating whether the property is currently for sale, or was sold in the last 12 months, 1-5 years and so on. As such, the geographic locations 207 of properties classified as having been sold in the last 20-30 years may be provided to the polygon recognition controller 112. As such, the polygon recognition controller 112 uses the proximity of the provided geographic locations 207 to the building outlines 206 to recognise the shape of the polygon 202 and to colour the polygon according to the colour coding for the classification.

Selecting the classification options within the legend 208 would cause the polygonal item controller 115 to display the respectively classified polygons 202.

In embodiments, the system 100 may convert property street address data into GIS geographic location data using a geocoding process to transforms a physical street address into a pair of latitude and longitude coordinates of the geographic locations 207 for spatial analysis. This process may begin with the input of a street address into a geocoding service which searches a precompiled database containing a vast array of addresses and their corresponding geographic locations. Once the input address is matched with an address in the database, the system retrieves the latitude and longitude coordinates associated with that address. If the exact address cannot be found, the system 100 may use interpolation to estimate the geographic location 207 based on nearby addresses.

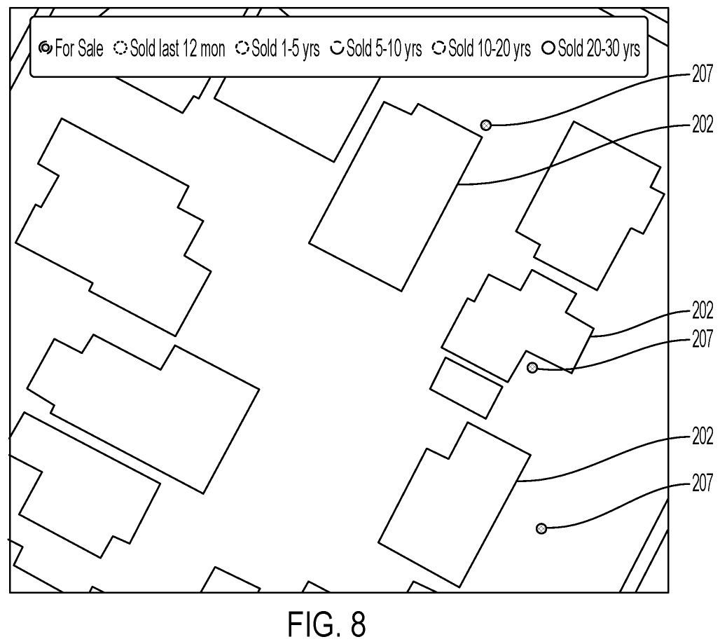

FIG. 8 shows an embodiment however wherein provided geographic locations 207 do not coincide (i.e., fall within the boundaries) of respective building outlines 206 which may be caused by calibration offsets of satellite image data, interpolation or the like. In accordance with this embodiment, the polygon recognition controller 112 uses a proximity analysis technique to identify the most closely position the building outlines 202. The polygon recognition controller 112 may perform proximity analysis by receiving a specific geographic coordinate 207 (latitude and longitude) representing a location of interest and then calculating the distance from this point to the boundaries of nearby polygons 202. The calculation of distances can be performed using the Euclidean distance, which measures the shortest straight-line distance between the point and the polygon boundary. Once all distances are calculated, the polygon recognition controller 112 identifies the polygon 202 with the shortest distance to the provided location 207, effectively finding the closest polygon 202 which are then rendered accordingly by the polygonal item controller 111 as is illustrated in FIG. 7.

In embodiments, the map user interface 120 is controllable by users to generate the polygonal icons 102, including placing new polygonal icons 102, and controlling the shape thereof.

In this regard, the map user interface 120 may comprise polygonal icon controls (not shown) and wherein the polygonal icon controller 111 is configured to update the polygonal data 107 responsive to user interface interaction with these polygonal icon controls.

In one embodiment, these polygonal icon controls may comprise controllable vertices which may be dragged by the user on screen to control the boundaries of a polygon. Additional vertices may be added for more complex shapes.

In alternative embodiments, the polygonal icon controls comprise geometric shapes which can be dragged and dropped into placement on screen. For example, a user may drag geometric shapes onto the satellite image data to best fit the boundaries of a property shown in the satellite image data. A property may be constructed from a plurality of geometric shapes to follow the boundaries of the property.

In embodiments, the data classifier controller 113 is configured to classify the polygonal icons 102 and wherein the polygonal icon controller is configured to display the polygonal icons 102 in the interactive map user interface 120 according to the classification.

As shown in FIG. 2, the various polygonal icons 102 may be displayed colour coded according to the classification.

In embodiments, the data classifier controller 113 is configured to receive data from the data server 101 for the purposes of the classification of the polygonal icons 202.

For example, in the embodiment shown in FIG. 2, the classification relates to the last sale date of a property represented by a polygonal icon 202. In accordance with this embodiment, the server 102 may retrieve property sale date data from a property data server 101 for the purposes of classification.

The interactive map user interface 120 may comprise a colour-coded legend 204 correspond to the classifications of the polygonal icons 202.

In accordance with the present example, the polygonal icons 202 may be colour coded according to classifications such as whether the corresponding property is currently for sale, was sold in the last year, sold within the last five years and so on.

In embodiments, users may register their user profiles 106 against polygonal icons 102 associated with their properties.

In accordance with this embodiment, the user profile controller 112 is configured to register user profile data 106 against respective polygonal data 107. In embodiments, polygonal icons 202 are selectable to cause the user profile controller to display a profile registration interface.

The profile registration interface may allow a user to create a user profile such as by providing login details and associated data including identification data, demographic data, contact data and the like.

In embodiments, the user profile controller 115 is further configured to allow users to upload additional data in relation to their associated polygonal icons 202 for public display to other users of the system 100.

For example, a user may upload text data, image data, video data and or the like which are stored by the server 102 and which is displayed to other users of the system. For example, another user may select a polygonal icon 202 to display the information uploaded by the user associated with the user profile 106 associated with the polygonal icon 202.

In embodiments, users of the system 100 may interact with the polygonal icons 202 including participating in interactive games controlled by the interactive game controller 123.

In one example, one type of interactive property game that may be controlled by the interactive game controller 123 involves selecting and placing property shapes onto a map grid representing a suburban area. The player uses a drag-and-drop mechanism to match property shapes with corresponding building polygons. The goal is precise placement, with points earned for accuracy and completion speed. As levels progress, challenges increase with more complex polygons and diverse property types (residential, commercial, etc.). The interactive game may feature visually appealing graphics, a user-friendly interface, and encourages strategic thinking to achieve high scores.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A system for controlling an interactive map user interface, the system comprising a server in operable communication with a plurality of computing devices across a wide area network, the server comprising a processor executing computer program code instruction controllers, including:
a user interface controller configured to generate an interactive map user interface for display by digital displays of the computing devices, the user interface comprising a map and navigational controllers for navigating the map; and
a polygonal icon controller configured to generate a plurality of polygonal icons in relation to the map, wherein the user interface controller is configured to overlay the map with the polygonal icons.

2. The system as claimed in claim 1, wherein the polygonal icon controller interfaces a polygon recognition controller, wherein the polygon recognition controller is configured to recognise polygons using building outlines included in satellite image data associated with the map.

3. The system as claimed in claim 2, wherein the polygon recognition controller employs edge detection on the building outlines to determine vertices and intersecting lines of quadrilateral shapes of the polygonal icons.

4. The system as claimed in claim 2, wherein the polygon recognition controller is provided with a geographic location and wherein the polygon recognition controller is configured to recognise a polygon using a building outline coinciding with the geographic location.

5. The system as claimed in claim 4, wherein the system is configured to convert street address data to obtain the geographic location.

6. The system as claimed in claim 2, wherein the polygon recognition controller is provided with a geographic location and wherein the polygon recognition controller is configured to employ proximity analysis to identify a building outline or polygon closest to the geographic location.

7. The system as claimed in claim 6, wherein the proximity analysis comprises the polygon recognition controller calculating straight-line distances from the geographic location to a plurality of building outlines or polygons and selecting the shortest straight-line distance to identify the closest building outline or polygon.

8. The system as claimed in claim 4, wherein the geographic location is associated with a classification and wherein the polygonal icon controller is configured to display the polygonal icons in the user interface according to the classification.

9. The system as claimed in claim 1, wherein the polygonal icon controller is configured to generate a quadrilateral shape of a polygonal icon by drawing lines in series between vertices.

10. The system as claimed in claim 9, wherein the polygonal icon controller is configured to draw lines in series between vertices.

11. The system as claimed in claim 10, wherein the polygonal icon controller is configured to determine a polygonal centre with reference to the vertices.

12. The system as claimed in claim 9, wherein the polygonal icon controller is configured to generate a parallelogram shape by generating parallel lines between respective vertices.

13. The system as claimed in claim 12, wherein the polygonal icon controller is configured to determine a polygonal centre and to select the surrounding vertices for the generation of the parallel lines.

14. The system as claimed in claim 9, wherein the polygonal icon controller is configured to fill the lines.

15. The system as claimed in claim 14, wherein the polygonal icon controller is configured to fill the lines according to a polygonal icon classification.

16. The system as claimed in claim 1, wherein the user interface comprises polygonal icon controls and wherein the polygonal icon controller is configured to update polygonal data responsive to user interface interactions with the polygonal icon controls.

17. The system as claimed in claim 16, wherein the polygonal icon controls are configured for adjusting vertices of the polygonal icons.

18. The system as claimed in claim 16, wherein the polygonal icon controls comprise shape drag and drop functionality.

19. The system as claimed in claim 1, further comprising a data classifier controller configured to classify the polygonal icons and wherein the polygonal icon controller is configured to display the polygonal icons in the user interface according to the classification.

20. The system as claimed in claim 19, wherein the classification is colour-coded in the interactive map user interface.

21. The system as claimed in claim 19, wherein the user interface comprises a colour-coded legend corresponding to classifications of the polygonal icons.

22. The system as claimed in claim 19, wherein the data classifier controller is configured to retrieve data from a third-party server for calculating the classifications.

23. The system as claimed in claim 1, wherein the controllers further comprise user profile controller configured to register user profiles against respective polygonal icons.

24. The system as claimed in claim 23, wherein each polygonal icon is selectable to cause the user interface to display a profile registration interface.

25. The system as claimed in claim 23, wherein the user profile controller is configured to record uploaded data in relation to user profiles and wherein respective polygonal icons are selectable in the user interface to display the uploaded data.

26. The system as claimed in claim 1, further comprising an interactive game controller allowing user interaction with the polygonal icons to participate in an interactive game.

27. The system as claimed in claim 26, wherein the interactive game involves selecting and placing property shapes onto the map grid using a drag-and-drop mechanism to match property shapes with corresponding polygonal icons.

28. The system as claimed in claim 27, wherein the interactive game controller is configured to measure placement preciseness of the shapes in relation to the polygonal icons.

29. The system as claimed in claim 27, wherein the interactive game controller is configured to measure placement speed of the shapes in relation to the polygonal icons.
